(19) United States
(12) Patent Application Publication
(10) Pub. No.: US 2019/0260080 A1
(43) Pub. Date: Aug. 22, 2019

(54) Non-aqueous Electrolyte and Lithium Secondary Battery Including the Same

(71) Applicant: LG Chem, Ltd., Seoul (KR)

(72) Inventors: Yu Ra Jeong, Daejeon (KR); Kyoung Ho Ahn, Daejeon (KR); Sol Ji Park, Daejeon (KR); Won Kyung Shin, Daejeon (KR); Chul Haeng Lee, Daejeon (KR)

(73) Assignee: LG Chem, Ltd., Seoul (KR)

(21) Appl. No.: 16/402,425

(22) Filed: May 3, 2019

Related U.S. Application Data
(63) Continuation-in-part of application No. PCT/KR2017/013282, filed on Nov. 21, 2017.

(30) Foreign Application Priority Data
Nov. 24, 2016 (KR) 10-2016-0157555
Nov. 20, 2017 (KR) 10-2017-0154623

(51) Int. Cl. H01M 10/0568; H01M 10/0569; H01M 10/0525

(52) U.S. Cl. CPC H01M 10/0568; H01M 2300/0028; H01M 10/0525; H01M 10/0569

(57) ABSTRACT

The present invention relates to a non-aqueous electrolyte, and more particularly, to a non-aqueous electrolyte including lithium bis fluoro sulfonyl imide as a lithium salt and an organic solvent, wherein the content of the lithium salt is 3.5 M or more.

### CROSS-REFERENCE TO RELATED APPLICATIONS

The present application is a continuation-in-part of International Application No. PCT/KR2017/013282 filed Nov. 21, 2017, which claims priority from Korean Patent Application No. 10-2016-0157555 filed Nov. 24, 2016 and Korean Patent Application No. 10-2017-0154623 filed Nov. 20, 2017, all of which are incorporated herein by reference

### TECHNICAL FIELD

### Technical Field

The present invention relates to a non-aqueous electrolyte and a lithium secondary battery including the non-aqueous electrolyte.

### Background Art

Demand for secondary batteries as an energy source has been significantly increased as technology development and demand with respect to mobile devices have increased. Accordingly, a great deal of research on batteries that can meet various needs is being carried out.

Particularly, demand for lithium secondary batteries, such as a lithium ion battery or a lithium ion polymer battery having merits of high energy density, high discharge voltage, output stability, or the like is high.

These lithium secondary batteries are charged and discharged while repeating a process of intercalation, in which lithium ions are intercalated into a graphite electrode of a negative electrode from a lithium metal oxide of a positive electrode, and deintercalation.

At this point, lithium ions, due to strong reactivity thereof, react with a carbon electrode to generate Li₂CO₃, LiO, LiOH, or the like and form a solid electrolyte interface (SEI) film on the surface of the negative electrode. The SEI film formed in an initial stage of charging functions as an ion tunnel which prevents the decomposition of electrolyte during charging and discharging and prevents high-molecular weight organic solvents that solvate and move together with lithium ions from being cointercalated into the graphite electrode and destroying the structure of the graphite electrode. The higher stability and the lower resistance the SEI film has, the further the service life of the lithium secondary battery may be enhanced. Accordingly, to enhance the high-temperature characteristics and the low-temperature output of the lithium secondary battery, a stable SEI film should be formed.

Recently, various research on the stabilization of the SEI film have been carried out. Regarding this, patent document 1 discloses a non-aqueous electrolyte including 0.01 M to 2 M of lithium bis fluoro sulfonyl imide (LiFSI) and an additive mixture.

However, the non-aqueous electrolyte disclosed in patent document 1 uses 0.01 M to 2 M of an electrolytic salt, so that there is a limit in ionic conductivity and thereby has a limitation in the performance of the secondary battery.

Thus, a high-concentration electrolyte, which has merits in terms of high output, quick charge, low-temperature output, battery stability, a high loading characteristic, and the like by using a high-concentration electrolyte having a higher transference number than the widely used electrolyte, is being demanded.

### PRIOR ART DOCUMENT

(Patent document 1) Korean Patent Application Laid-open Publication No. 10-2016-0036810

### DISCLOSURE OF THE INVENTION

### Technical Problem

To solve the aforementioned limitations, a first technical problem of the present invention is to provide a non-aqueous electrolyte for lithium secondary batteries which is capable of improving low-temperature output characteristics by using a high-concentration non-aqueous electrolyte of 3.5 M or more.

A second technical problem of the present invention is to provide a non-aqueous electrolyte for lithium secondary batteries which is capable of improving cycle performance by using an additional additive.

In addition, a third technical problem of the present invention is to provide a lithium secondary battery including the non-aqueous electrolyte.

### Technical Solution

Specifically, according to an aspect of the present invention, there is provided a non-aqueous electrolyte including lithium bis fluoro sulfonyl imide (LiFSI) as a lithium salt and a nitrile-based organic solvent and the concentration of the lithium salt is 3.5 M or more.

According to another aspect of the present invention, there is provided a lithium secondary battery including a positive electrode and a negative electrode, a separator interposed between the positive electrode and the negative electrode; and a non-aqueous electrolyte of the present invention.

### Advantageous Effects

As described so far, a non-aqueous electrolyte including a high-concentration lithium salt of LiFSI of 3.5 M or more according to the present invention is capable of achieving an output effect by using a high-concentration electrolyte having a high yield.

In addition, by using an additive in addition to the non-aqueous electrolyte, the service life over cycles of the non-aqueous solution including a high-concentration lithium salt of LiFSI can also be improved.

### BRIEF DESCRIPTION OF THE DRAWINGS

FIG. 1 is a comparison graph showing output characteristics of a lithium secondary battery according to examples and comparative examples of the present invention; and

FIG. 2 is a comparison graph showing cycle characteristics of a lithium secondary battery according to examples and comparative examples of the present invention.

### BEST MODE FOR CARRYING OUT THE INVENTION

Hereinafter the present invention will be described in more detail.

It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

Specifically, a non-aqueous solution according to an embodiment of the present invention includes a lithium salt of LiFSI of 3.5 M or more and a nitrile-based organic solvent.

Although any lithium salt may be LiFSI; or combination of LiFSI and lithium hexafluoro phosphate (LiPF₆).

The concentration of the LiFSI is 3.5 M or more and may favorably be 3.5 M to 6 M. When a non-aqueous electrolyte including a high-concentration LiFSI of 3.5 M to 6 M is used, the non-aqueous electrolyte including the above concentration may achieve a high transference number and also achieve an effect of reducing diffusion resistance of lithium ions.

The organic solvent included in the non-aqueous electrolyte according to the present invention may be a nitrile-based solvent.

The nitrile-based solvent may be, acetonitrile (ACN), propionitrile, butyronitrile, valeronitrile, caprylonitrile, heptane nitrile, cyclo-pentane-carbonitrile, cyclo-hexane carbonitrile, 2-fluoro-benzonitrile, 4-fluoro-benzonitrile, difluoro-benzonitrile, trifluoro-benzonitrile, phenyl acetonitrile, 2-fluoro-phenyl acetonitrile, and 4-fluoro-phenyl acetonitrile, or a combination thereof. Among these nitrile-based solvent, acetonitrile is preferably used.

In addition to the nitrile-based organic solvent, the non-aqueous electrolyte of the present invention may further include an organic solvent selected from the group consisting of a carbonate-based solvent, an ether-based solvent, an ester-based solvent, or the combination thereof.

The carbonate-based compounds may be divided into cyclic carbonate compounds and linear carbonate compounds. The cyclic carbonate compounds include any one selected from the group consisting of ethylene carbonate (EC), propylene carbonate (PC), 1,2-butylene carbonate, 2,3-butylene carbonate, 1,2-pentylene carbonate, 2,3-pentylene carbonate, vinylene carbonate, and fluoro-ethylene carbonate (FEC), or a mixture of two or more thereof. In addition, the linear carbonate compounds include any one selected from the group consisting of dimethyl carbonate (DMC), diethyl carbonate (DEC), dipropyl carbonate, ethylmethyl carbonate (EMC), methylpropyl carbonate, and ethylpropyl carbonate, or a mixture of two or more thereof.

In particular, among the carbonate compounds, it may be desirable to use the ethylene carbonate and the propylene carbonate, which are cyclic carbonate compounds, because the ethylene carbonate and the propylene carbonate are high-viscosity organic solvents, have high dielectric constants, and thus easily dissociate a lithium salt in the electrolyte. In addition, when a linear carbonate having low viscosity and low dielectric constant is used by being added to such a cyclic carbonate with an appropriate ratio, an electrolyte having a high electrical conductivity may be prepared, and thus may be more favorably used.

In addition, as the ether-based compound, any one selected from the group consisting of dimethyl ether, diethyl ether, dipropyl ether, methylethyl ether, methylpropyl ether, and ethylpropyl ether, or a mixture of two or more thereof may be used, but not limited thereto.

In addition, as the ester-based compound, any one selected from the group consisting of linear esters such as methyl acetate, ethyl acetate, propyl acetate, methyl propionate, ethyl propionate, propyl propionate, and butyl propionate; and cyclic esters such as γ-butyrolactone, γ-valerolactone, γ-caprolactone, σ-valerolactone, and ε-caprolactone, or a mixture of two or more thereof may be used, but not limited thereto.

Meanwhile, if necessary, the non-aqueous electrolyte according to the present invention may further include additives in addition to the lithium solvent and the organic solvent.

The additives include vinylene carbonate (VC), oxalyldifluoroborate (ODFB), vinyl ethylene carbonate (VEC), succinic anhydride (SA), succino nitrile (SN), 1,3-propane sultone (PS), or a combination thereof. The additives favorably include vinylene carbonate (VC), and most favorably include vinylene carbonate (VC) and oxalyldifluoroborate (ODFB). When a secondary battery is manufactured by adding the additives into the non-aqueous electrolyte, the additive together with the lithium salt forms a stable SEI film on a negative electrode and may thereby improve the output characteristics, suppress the decomposition of the surface of a positive electrode, and prevent an oxidation reaction of the electrolyte. Accordingly, the output characteristics of a secondary battery may be effectively improved. In addition, the additives suppress Al corrosion and Cu damage and thus, the life characteristics over cycles may be improved.

The additives may be included in an amount of 0.1 wt % to 10 wt %, favorably, 0.5 wt % to 3 wt % based on the total weight of the non-aqueous electrolyte, When the additive is included in an amount of less than 0.1 wt %, the effect of improving the low-temperature output characteristics and the high-temperature stability characteristics may be unsatisfactory, and when the content of the additive exceeds 10 wt %, a side reaction may excessively occur in the non-aqueous during charging and discharging of the secondary battery.

In particular, when an excessive amount of the additives are added into the non-aqueous electrolyte, the additives may not sufficiently be decomposed at high temperature and remain as an unreacted substance at room temperature, and thus, the service life characteristics or resistance characteristics may be degraded.

Manufactured by appropriately combining and adding, if necessary, the additives into the non-aqueous electrolyte, the lithium secondary battery according to the present invention may have improved output characteristics, form a stable SEI film on the surface of the negative electrode, effectively suppress the decomposition of the electrolyte, have also improved cycle characteristics, and finally, may have improved stability.

Meanwhile, a lithium secondary battery according to the present invention includes: a positive electrode and a negative electrode; a separator interposed between the positive electrode and the negative electrode; and a non-aqueous electrolyte of the present invention.

The non-aqueous electrolyte is the same as described above, and thus, specific descriptions thereof will not be provided, and only the remaining configuration thereof will be described hereinafter in detail.

Specifically, the lithium secondary battery according to the present invention may be manufactured by injecting the non-aqueous electrolyte of the present invention into an electrode structure including a positive electrode, a negative electrode, a separator interposed between the positive electrode and the negative electrode. At this point, as the positive electrode, the negative electrode, and the separator which constitute the electrode assembly, all those generally used for manufacturing a lithium secondary battery may be used.

At this point, the positive electrode may be manufactured applying a positive electrode mixture including a positive electrode active material, a binder, a conductive agent, a solvent, and the like on to a positive electrode collector to coat the positive electrode collector.

The positive electrode collector may be any collector, provided that the collector does not cause a chemical change in the battery and has conductivity. For example, stainless steel, aluminum, nickel, titanium, calcined carbon, or aluminum or stainless steel with a surface treated with carbon, nickel, titanium, silver, or the like.

The positive electrode active material is a compound in which reversible intercalation and deintercalation of lithium can be performed, and specifically, may contain a lithium-metal composite oxide including lithium and one or more metal such as cobalt, manganese, nickel or aluminum. More specifically, the lithium-metal composite oxide may be: a lithium-manganese-based oxide (e.g., LiMnO₂, LiMn₂O₄, etc.), a lithium-cobalt-based oxide (e.g., LiCoO₂ etc.), a lithium-nickel-based oxide (e.g., LiNiO₂ etc.), a lithium-nickel-manganese oxide (e.g., LiNi_{1-y}Mn₁O₂ (where, O<Y<1), LiMn_{2-z}Ni_{z}O₄ (where, O<Z<2), etc.), a lithium-nickel-cobalt-based oxide (e.g., LiNi_{1-Y1}Co_{Y1}O₂ (where, O<Y1<1), etc.), a lithium-manganese-cobalt-based oxide (e.g., LiCo_{1-Y2}Mn_{Y2}O₂ (where, 0<Y2<1), LiMn_{2-z1}Co_{z1}O₄ (where, 0<Z1<2), etc.), a lithium-nickel-manganese-cobalt-based oxide (e.g., Li(NiₚCo_{q}Mnᵣ₁)O₂ (where, 0<p<1, 0<q<1, 0<r1<1, p+q+r1=1), Li(Niₚ₁Co_{q1}Mnᵣ₂)O₄ (where, 0<p1<2, 0<q1<2, 0<r2<2, p1+q1+r2=2), etc.), a lithium-nickel-cobalt-transition metal (M) oxide (e.g., Li(Niₚ₂Co_{q2}Mnᵣ₃Mₛ₂)O₂ (where, M is selected from the group consisting of Al, Fe, V, Cr, Ti, Ta, Mg and Mo, p2, q2, r3 and s2 are respectively atomic fractions of independent elements such that 0<p2<1, 0<q2<1, 0<r3<1, 0<s2<1, p2+q2+r3+s2=1), etc.), or the like, and any one thereof or a compound of one or more thereof may be included. Among these, in terms of capability of enhancing the capacity characteristics and stability, the lithium-metal composite oxide may be: LiCoO₂, LiMnO₂, LiNiO₂, a lithium-nickel-manganese-cobalt oxide (e.g., Li(Ni_{0.6}Mn_{0.2}CO_{0.2})O₂, Li(Ni_{0.5}Mn_{0.3}CO_{0.2}) O₂, Li(Ni_{0.2}Mn_{0.15}Co_{0.15}) O₂, Li(Ni_{0.8}Mn_{0.1}Co_{0.1}) O₂, or the like), a lithium-nickel-cobalt-aluminum oxide (e.g., LiNi_{0.8}Co_{0.15}Al_{0.05}O₂ or the like), or the like. In addition, considering that a remarkable improvement effect may be achieved according to a control of the type and content of constituent elements constituting the lithium-metal composite oxide, the lithium-metal composite oxide may be: Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂, or the like, and any one thereof or a mixture of two or more thereof may be used.

The positive electrode active material may be included in an amount of 80 wt % to 90 wt % based on the total weight of the positive electrode mixture.

The binder is a component which assists binding between the active material and a conductive agent or the like, and between the active material and the collector, and is generally added in an amount of 1 wt % to 30 wt % based on the total weight of the positive electrode mixture. For example, the binder may include poly vinylidene, poly vinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, styrene butylene rubber, fluoro rubber, or various copolymers.

The conductive agent is generally added in an amount of 1 wt % to 30 wt % based on the total weight of the positive electrode mixture.

The conductive agent may be any material, provided that the conductive material does not cause a chemical change in the battery and has conductivity. For example, the conductive material may include: graphite; a carbon-based material such as carbon black, acetylene black, Ketjen black, channel black, furnace black, lamp black, and thermal black; conductive fibers such as carbon fibers and metal fibers; metal powder such as carbon fluoride, aluminum, and nickel powder; conductive whisker such as zinc oxide and potassium titanate; conductive metal oxide such as titanium oxide; or conductive material such as polyphenylene derivatives may be used.

Specific examples of commercialized conductive agents include: acetylene black series of Chevron Chemical Company, Denka black (Denka Singapore Private Limited), products of Gulf Oil Company, Ketjenblack, EC series (products of Armak company), Vulcan XC-72 (products of Cabot company), Super P (products of Timcal Ltd.), and the like.

The solvent used to manufacture the positive electrode mixture may include an organic solvent, such as N-methyl-2-pyrrolidone (NMP), and the solvent may be used in an amount such that the solvent has a desirable viscosity when including the positive electrode active material and selectively including the binder, the conductive agent, and the like. For example, the positive electrode active material, the binder and the conductive agent may be included in the solid component so that the content of a solid component including the positive electrode active material, and selectively including the binder and the conductive agent reaches 50 wt % to 95%, preferably, 70 wt % to 90 wt %.

In addition, the negative electrode may be manufactured by including a metallic material such as a lithium metal or a lithium alloy, and a carbon material such as a low crystalline carbon, a high crystalline carbon, or by applying, on a negative electrode collector, a negative electrode mixture including a negative electrode active material, a binder, a conductive agent, a solvent and the like to coat the collector.

The negative electrode collector generally has a thickness of 3 μm to 500 μm. The negative electrode collector may include any material, provided that the collector does not cause a chemical change in the battery and has high conductivity. For example, copper, stainless steel, aluminum, nickel, titanium, calcined carbon, copper or stainless steel with a surface treated with carbon, nickel, titanium, or silver, or an aluminum-cadmium alloy may be used. Like the positive electrode collector, the negative electrode collector may also have an uneven surface to improve bonding strength of a negative electrode active material, and may be used in various forms such as a film, a sheet, a foil, a net, a porous body, a foam body, or a non-woven fabric body.

The negative electrode active material may be one or two or more negative electrode active materials selected from the group consisting of: natural graphite, artificial graphite, or a carbonaceous material; a lithium-containing titanium composite oxide (LTO), or metals (Me) such as Si, Sn, Li, Zn, Mg, Cd, Ce, Ni and Fe; alloys consisting of the metals (Me); an oxide of the metals (Me); and a composite of the metals (Me) and carbon.

The negative electrode active material may be included in an amount of 80 wt % to 99 wt % based on the total weight of the negative electrode mixture.

The binder is a component which assists binding between the active material and a conductive agent, and is generally added in an amount of 1 wt % to 30 wt % based on the total weight of the negative electrode mixture. For example, the binder may be poly vinylidene fluoride (PVDF), poly vinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, stylene-butylene rubber, fluoro rubber, or various copolymers thereof.

The conductive agent is a component for further improving the conductivity of the negative electrode active material, and may be added in an amount of 1 wt % to 20 wt % based on the total weight of the negative electrode mixture. The conductive material may be any material, provided that the conductive material does not cause a chemical change in the battery and has conductivity. For example, graphite such as natural graphite and artificial graphite; carbon black such as acetylene black, Ketjen black, channel black, furnace black, lamp black, and thermal black; conductive fiber such as carbon fiber and metal fiber; metal powder such as carbon fluoride, aluminum, and nickel powder; conductive whisker such as zinc oxide and potassium titanate; conductive metal oxide such as titanium oxide; or polyphenylene derivatives.

The solvent used to manufacture the positive electrode mixture may include water of an organic solvent, such as N-methyl-2-pyrrolidone (NMP), and the solvent may be used in an amount such that the solvent has a desirable viscosity when including the negative electrode active material and selectively including the binder, the conductive agent, and the like. For example, the negative electrode active material, the binder and the conductive agent may be included in the solid component so that the content of a solid component including the negative electrode active material, and selectively including the binder and the conductive agent reaches 50 wt % to 95%, preferably, 70 wt % to 90 wt %.

In addition, as the separator, a general porous polymer film conventionally used as a separator, for example, a porous polymer film prepared from polyolefin-based polymer, such as ethylene homopolymer, propylene homopolymer, ethylene/butene copolymer, ethylene/hexene copolymer and ethylene/methacrylate copolymer, may be singly used or used by being stacked. Alternatively, a general porous nonwoven, for example, a nonwoven fabric made of glass fiber having a high melting point, polyethylene terephthalate fiber, or the like may be used, but limited thereto.

The outer shape of the lithium secondary battery according to the present invention may be, but not limited to, a cylindrical shape using a can, a square shape, a pouch shape, a coin shape, or the like.

### MODE FOR CARRYING OUT THE INVENTION

Hereinafter an exemplary embodiment will be described in detail to specifically describe the present invention. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

### EXAMPLE

### Example 1

[Preparation of Non-Aqueous Electrolyte]

A non-aqueous electrolyte was prepared by dissolving LiFSI into an acetonitrile organic solvent in a concentration of 3.5 M.

[Manufacture of Positive Electrode]

A positive electrode mixture was prepared by adding, based on 100 parts by weight of N-methyl-2-pyrollidone (NMP) which is a solvent, 40 parts by weight of positive electrode mixture in which: lithium-cobalt composite oxide (LiCO₂) as positive electrode active material particles; carbon black as a conductive agent; and polyvinylidene fluoride (PVDF) as a binder were mixed with a ratio of 90:5:5 (wt %). The positive electrode mixture was applied onto a positive electrode collector (Al thin film) having a thickness of 100 μm, dried, and processed by a roll press, thereby manufacturing a positive electrode.

[Manufacture of Negative Electrode]

A negative electrode mixture was prepared by adding, based on 100 parts by weight of N-methyl-2-pyrollidone (NMP) which is a solvent, 80 parts by weight of negative electrode mixture in which natural graphite as a negative electrode active material; PVDF as a binder; and carbon black as a conductive agent were mixed with a ratio of 95:2:3 (wt %). The negative electrode mixture was applied onto a negative electrode collector (Cu thin film) having a thickness of 90 μm, dried, and processed by a roll press, thereby manufacturing a negative electrode.

[Manufacture of Secondary Battery]

A coin-type cell was manufactured through a general method by using the positive electrode and the negative electrode manufactured by the above-mentioned method together with a polyethylene porous film, and then, the prepared non-aqueous electrolyte was injected into the coin-type cell to manufacture a lithium secondary battery.

### Example 2

A non-aqueous electrolyte and a secondary battery including the same were prepared through the same method as that in Example 1 except that LiFSI was dissolved in a concentration of 4.5 M in the preparation of the non-aqueous electrolyte.

### Example 3

A non-aqueous electrolyte and a secondary battery including the same were prepared through the same method as that in Example 1 except that 1 wt % of vinylethylene carbonate (VEC) was added as an additive in the preparation of the non-aqueous electrolyte.

### Example 4

A non-aqueous electrolyte and a secondary battery including the same were prepared through the same method as that in Example 1 except that 1 wt % of succinic anhydride (SA) was added as an additive in the preparation of the non-aqueous electrolyte.

### Example 5

A non-aqueous electrolyte and a secondary battery including the same were prepared through the same method as that in Example 1 except that 1 wt % of succino-nitrile (SN) was added as an additive in the preparation of the non-aqueous electrolyte.

### Example 6

A non-aqueous electrolyte and a secondary battery including the same were prepared through the same method as that in Example 1 except that 1 wt % of 1,3-propanesultone (PS) was added as an additive in the preparation of the non-aqueous electrolyte.

### Example 7

A non-aqueous electrolyte and a secondary battery including the same were prepared through the same method as that in Example 1 except that 1 wt % of vinylene carbonate (VC) was added as an additive in the preparation of the non-aqueous electrolyte.

### Example 8

A non-aqueous electrolyte and a secondary battery including the same were prepared through the same method as that in Example 1 except that 1 wt % of oxalyldifluoroborate (ODFB) was added as an additive in the preparation of the non-aqueous electrolyte.

### Example 9

A non-aqueous electrolyte and a secondary battery including the same were prepared through the same method as that in Example 1 except that 2 wt % of VC and 1 wt % of ODFB were added as additives in the preparation of the non-aqueous electrolyte.

### Example 10

A non-aqueous electrolyte and a secondary battery including the same were prepared through the same method as that in Example 1 except that LiPF₆ and LiFSI were mixed with a molar ratio of 1:1 was dissolved in a concentration of 3.5 M in the preparation of the non-aqueous electrolyte.

### Example 11

A non-aqueous electrolyte and a secondary battery including the same were prepared through the same method as that in Example 1 except that LiPF₆ and LiFSI were mixed with a molar ratio of 1:1 was dissolved in a concentration of 4.5 M in the preparation of the non-aqueous electrolyte.

### COMPARATIVE EXAMPLE

### Comparative Example 1

An organic solvent mixture was prepared by mixing ethylene carbonate (EC), propylene carbonate (PC), and ethylmethyl carbonate (EMC) in a ratio of 10:20:70 (vol %). Then, based on total content of the prepared organic solvent mixture, vinylene carbonate (VC), 1,3-propanesultone (PS), and ethylene sulfate (ESA) were respectively further added in amounts of 1.5 wt %, 0.5 wt %, and 0.5 wt %, LiPF₆ and LiFSI were mixed with a molar ratio of 1:1 and dissolved to be a concentration of 1M, thereby preparing a non-aqueous electrolyte. Subsequently, a positive electrode, a negative electrode, and a secondary electrode were prepared through the same method as that in Example 1.

### Comparative Example 2

A non-aqueous electrolyte and a secondary battery including the same were prepared through the same method as that in Example 1 except that LiFSI was used in a concentration of 2.5 M in the preparation of the non-aqueous electrolyte.

### Comparative Example 3

A non-aqueous electrolyte and a secondary battery including the same were prepared through the same method as that in Example 1 except that LiPF₆ and LiFSI were mixed in a molar ratio of 1:1 to be used in a concentration of 1 M in the preparation of the non-aqueous electrolyte.

### Comparative Example 4

A non-aqueous electrolyte and a secondary battery including the same were prepared through the same method as that in Example 1 except that dimethyl carbonate was used as an organic solvent instead of acetonitrile in the preparation of the non-aqueous electrolyte.

### Comparative Example 5

A non-aqueous electrolyte and a secondary battery including the same were prepared through the same method as that in Example 1 except that LiTFSI was used as a lithium salt instead of LiFSI in the preparation of the non-aqueous electrolyte.

### Comparative Example 6

A non-aqueous electrolyte and a secondary battery including the same were prepared through the same method as that in Example 2 except that LiTFSI was used as a lithium salt instead of LiFSI in the preparation of the non-aqueous electrolyte.

### EXPERIMENTAL EXAMPLE

### Experimental Example 1: Low-Temperature Output Characteristics

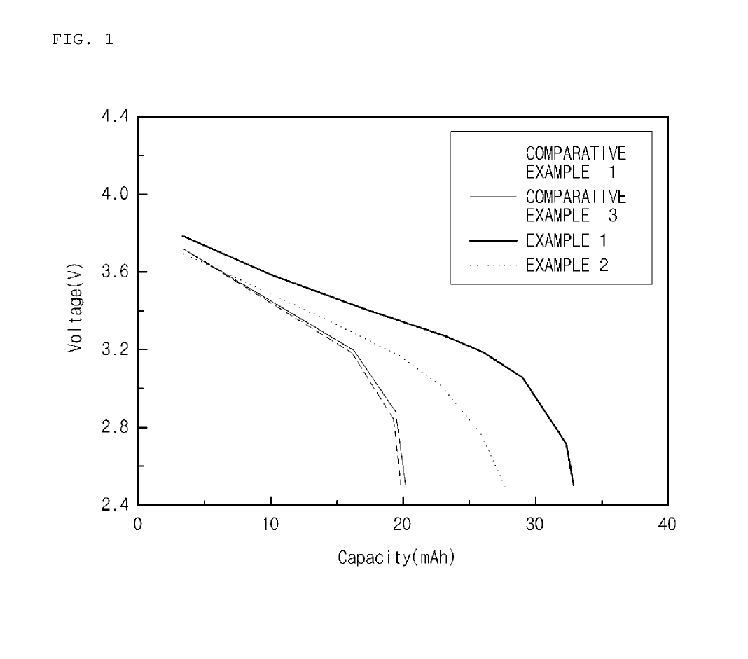

By using a voltage difference generated when the secondary batteries manufactured in Examples 1, 2, 10 and 11 and Comparative Examples 1, 3, 5 and 6 are charged and discharged, an output was calculated over time, and the results thereof are shown in FIG. 1 and Table 1 below.

TABLE 1

| | Lithium ion | | | | Additive | Resistance |
|---|---|---|---|---|---|---|
| | kind | Concentration | Solvent | additive | content | (Ω) |
| Example 1 | LiFSI | 3.5M | ACN | — | — | 1.21 |
| Example 2 | LiFSI | 4.5M | ACN | — | — | 1.56 |
| Example 10 | LiPF₆ + | 3.5M | ACN | — | — | 1.28 |
| | LiFSI | | | | | |
| | (1:1) | | | | | |
| Example 11 | LiPF₆ + | 4.5M | ACN | — | — | 1.58 |
| | LiFSI | | | | | |
| | (1:1) | | | | | |
| Comparative | LiPF₆ + | 1M | EC + PC + | VC + PS + | 1.5 wt % + | 1.60 |
| Example 1 | LiFSI | | EMC | ESA | 0.5 wt % + | |
| | (1:1) | | | | 0.5 wt % | |
| Comparative | LiPF₆ + | 1M | ACN | — | — | 1.60 |
| Example 3 | LiFSI | | | | | |
| | (1:1) | | | | | |
| Comparative | LiTFSI | 3.5M | ACN | — | — | 1.84 |
| Example 5 | | | | | | |
| Comparative | LiTFSI | 4.5M | ACN | — | — | 2.02 |
| Example 6 | | | | | | |

As shown in Table 1 and FIG. 1, the non-aqueous electrolyte of Examples 1 and 10, including a high-concentration LiFSI of 3.5 M, exhibited a lowest resistance of 1.21Ω and 1.28Ω separately. And, the non-aqueous electrolyte of Examples 2 and 11, including a high-concentration LiFSI of 4.5 M, exhibited a slightly higher resistance than that of Examples 1 and 10 whereas exhibited significantly lower resistance than that of Comparative Examples 5 and 6, including a high-concentration LiTFSI. Thus the output characteristics of the lithium secondary battery, using an electrolyte including a high-concentration LiFSI as a lithium salt and acetonitrile as an organic solvent could also be improved.

### Experimental Example 2: Cycle Characteristics

The cycle characteristics of the secondary batteries manufactured in Examples 1 to 8 and Comparative Example 2 were experimented.

The secondary batteries manufactured in Examples 1 to 8 and Comparative Example 2 (battery capacity 40 mAh) were charged/discharged 350 cycles at 25° C. and a charge/discharge rates of 1C/1C.

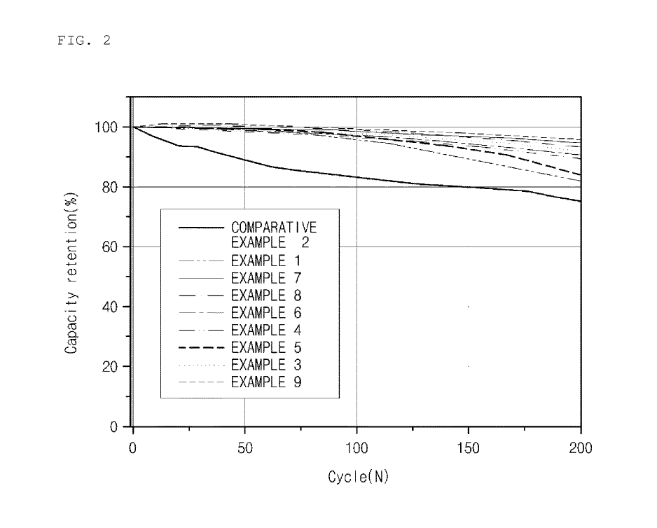

Specifically, the lithium secondary batteries having battery capacity of 40 mAh and manufactured in Examples 1 to 8 and Comparative Example 2 were charged at 25° C. and 1 C of constant current until reaching 4.15 V, then charged at a constant voltage of 4.15 V, and when the charging current reaches 2 mA, the charging was finished. Subsequently, after being left for 10 minutes, discharging was performed at a constant current of 1 C until reaching 3 V. The charge/discharge operations are set as 1 cycle, and this cycle was repeated 350 times, and then the charge/discharge capacities were measured according to Examples of the present invention and Comparative Examples, and the results are shown in Table 2 and FIG. 2 below.

Here, C denotes a C-rate, which is a charging/discharging rate of current expressed by ampere (A), and in general, C is expressed as a ratio of battery capacities.

TABLE 2

| | | | | | | Capacity |
|---|---|---|---|---|---|---|
| | Lithium ion | | | | Additive | retention |
| | Kind | Concentration | Solvent | Additive | content | (%) |
| Example 1 | LiFSI | 3.5M | ACN | — | | 82.12 |
| Example 3 | LiFSI | 3.5M | ACN | VEC | 1 Wt % | 92.07 |
| Example 4 | LiFSI | 3.5M | ACN | SA | 1 Wt % | 89.73 |
| Example 5 | LiFSI | 3.5M | ACN | SN | 1 Wt % | 84.42 |
| Example 6 | LiFSI | 3.5M | ACN | PS | 1 Wt % | 91.46 |
| Example 7 | LiFSI | 3.5M | ACN | VC | 1 Wt % | 95.19 |
| Example 8 | LiFSI | 3.5M | ACN | ODFB | 1 Wt % | 93.64 |
| Example 9 | LiFSI | 3.5M | ACN | VC + ODFB | 3 Wt % | 95.44 |
| Example 10 | LiPF₆ + | 3.5M | ACN | — | — | 86.26 |
| | LiFSI | | | | | |
| | (1:1) | | | | | |
| Comparative | LiFSI | 2.5M | ACN | — | — | 75.73 |
| Example 2 | | | | | | |
| Comparative | LiPF₆ + | 1M | ACN | — | — | |
| Example 3 | LiFSI | | | | | |
| | (1:1) | | | | | |
| Comparative | LiTFSI | 3.5M | ACN | — | — | 62.04 |
| Example 5 | | | | | | |

As shown in Table 2 above and FIG. 2, the non-aqueous electrolyte of Example 1, including a high-concentration LiFSI of 3.5 M, exhibited excellent cycle characteristics compared to the case (Comparative Example 2) in which the conditions were the same except for a low concentration of LiFSI. In addition, when not only a high-concentration LiFSI of 3.5M but also an additive was added, it was found that the cycle characteristics were further improved. It was found that this was because according to the addition of the additive, Al corrosion and Cu damage of the secondary battery are suppressed, and thus the service life characteristics over cycle was improved.

Meanwhile, when the conditions are nearly the same but the concentration of the LiFSI was 1 M, which was lower than that in Comparative Example 2, the lithium secondary battery was hardly operated, and thus, the capacity retention could not be measured. In other words, it could be found that when a nitrile-based solvent was used as a solvent for electrolyte, a high-concentration LiFSI of 3.5 M or more was desirable.

Although the non-aqueous electrolyte including a high-concentration lithium salt of 3.5 M was used, it could be found that when LiTFSI instead of LiFSI was used as a lithium salt (Comparative Example 5), cycle characteristics was significantly reduced due to a corrosion of the current collector.

### Experimental Example 3: Measurement of Viscosity and Ion Conductivity of Electrolyte

The ion conductivity and the viscosity of the non-aqueous electrolyte prepared in Example 1 and Comparative Example 4 were respectively measured by using probe-type ion conductivity measuring apparatus (Inolab 740 apparatus) at 25° C. and by using a RS150 viscometer at 25° C. Results of the measurement are shown in Table 3 below.

TABLE 3

| | | Ion conductivity |
|---|---|---|
| Electrolyte | Viscosity (cP) | (mS/cm) |
| Example 1 (3.5M | 12.2 | 14.4 |
| LiFSI in ACN) | | |
| Comparative Example | 21.8 | 4.64 |
| 4 (3.5M LiFSI in | | |
| DMC) | | |
| Comparative Example | 15.4 | 10.1 |
| 5 (3.5M LiTFSI in | | |
| DMC) | | |

As shown in Table 3, it could be found that when the concentration of the lithium salt (LiFSI) was as high as 3.5 M, the viscosity was lower and the ion conductivity was higher in the case (Example 1) of using a nitrile-based solvent than in the case (Comparative Example 4) of using a dimethyl carbonate solvent.

In addition, even when a high-concentration LiFSI is contained, only a carbonate-based solvent is used as the solvent of an electrolyte, ion conductivity is lowered and thus, there is a limitation in improving the performance of the secondary battery.

Although the non-aqueous electrolyte including a high-concentration lithium salt was used, it could be found that when LiTFSI was used as a lithium salt (Comparative Example 5), the viscosity of the electrolyte was higher than the electrolyte including LiFSI and the ion conductivity was lower than the electrolyte including LiFSI.

That is, it can be predicted that when an acetonitrile solvent and an electrolyte containing a high-concentration LiFSI were applied to a lithium secondary battery, there is an effect of improving the performance of the battery.

1. A non-aqueous electrolyte comprising: lithium bis fluoro sulfonyl imide as a lithium salt; and a nitrile-based organic solvent, wherein the concentration of the lithium salt is 3.5 M or more.

2. The non-aqueous electrolyte of claim 1, wherein the concentration of the lithium salt is 3.5 M to 6 M.

3. The non-aqueous electrolyte of claim 1, wherein the lithium salt further comprises lithium hexafluoro phosphate.

4. The non-aqueous electrolyte of claim 1, wherein the nitrile-based organic solvent is selected from the group consisting of acetonitrile, propionitrile, butyronitrile, valeronitrile, caprylonitrile, heptane nitrile, cyclo-pentane-carbonitrile, cyclo-hexane carbonitrile, 2-fluoro-benzonitrile, 4-fluoro-benzonitrile, difluoro-benzonitrile, trifluoro-benzonitrile, phenyl acetonitrile, 2-fluoro-phenyl acetonitrile, and 4-fluoro-phenyl acetonitrile, or a combination thereof.

5. The non-aqueous electrolyte of claim 1, wherein the nitrile-based organic solvent is acetonitrile.

6. The non-aqueous electrolyte of claim 1, further comprising an organic solvent selected from the group consisting of an ester-based solvent, an ether-based solvent, a carbonate-based solvent, and a combination thereof.

7. The non-aqueous electrolyte of claim 1, further comprising an additive.

8. The non-aqueous electrolyte of claim 7, wherein the additive is selected from the group consisting of vinylene carbonate (VC), oxalyldifluoroborate (ODFB), vinyl ethylene carbonate (VEC), succinic anhydride (SA), succino nitrile (SN), 1,3-propane sultone (PS), and a combination thereof.

9. The non-aqueous electrolyte of claim 7, wherein the additive is added in an amount of 0.1 wt % to 10 wt % based on the total weight of the non-aqueous electrolyte.

10. A lithium secondary battery comprising: a positive electrode; a negative electrode; a separator interposed between the positive electrode and the negative electrode; and the non-aqueous electrolyte of claim 1.

11. The non-aqueous electrolyte of claim 6, wherein the carbonate-based solvent comprises a cyclic carbonate compound or a linear carbonate compound.

12. The non-aqueous electrolyte of claim 11, wherein the cyclic carbonate compound comprises any one selected from the group consisting of ethylene carbonate (EC), propylene carbonate (PC), 1,2-butylene carbonate, 2,3-butylene carbonate, 1,2-pentylene carbonate, 2,3-pentylene carbonate, vinylene carbonate, fluoro-ethylene carbonate (FEC), and a mixture of two or more thereof.

13. The non-aqueous electrolyte of claim 11, wherein the linear carbonate compound comprises any one selected from the group consisting of dimethyl carbonate (DMC), diethyl carbonate (DEC), dipropyl carbonate, ethylmethyl carbonate (EMC), methylpropyl carbonate, ethylpropyl carbonate, and a mixture of two or more thereof.

14. The non-aqueous electrolyte of claim 6, wherein the ether-based compound comprises any one selected from the group consisting of dimethyl ether, diethyl ether, dipropyl ether, methylethyl ether, methylpropyl ether, ethylpropyl ether, and a mixture of two or more thereof.

15. The non-aqueous electrolyte of claim 6, wherein the ester-based compound comprises any one selected from the group consisting of linear esters such as methyl acetate, ethyl acetate, propyl acetate, methyl propionate, ethyl propionate, propyl propionate, and butyl propionate; and cyclic esters such as γ-butyrolactone, γ-valerolactone, γ-caprolactone, σ-valerolactone, ε-caprolactone, and a mixture of two or more thereof.
